(19) United States
(12) Patent Application Publication
(10) Pub. No.: US 2003/0169006 A1
(43) Pub. Date: Sep. 11, 2003

(54) DC motor driver circuit for use with photovoltaic power source

(76) Inventor: Peter L. Allen, Halifax (CA)

Correspondence Address: JOHN A. BAKER, KIRBY EADES GALE BAKER, BOX 3432, STATION D, OTTAWA, K1P 6N9, CA

(21) Appl. No.: 10/090,835

(22) Filed: Mar. 6, 2002

(51) Int. Cl. H02P 1/00; H02P 3/00; H02P 5/00; H02P 7/00

(52) U.S. Cl. 318/442

(57) ABSTRACT

This invention comprises a DC motor driving circuit for use with a solar powered heating system and other applications such as solar powered irrigation or pumping. The circuit, in addition to functioning as a DC-to-DC converter between a photovoltaic (PV) power source and a motor, also contains a short term energy storage capability that is used to provide a jolt of current to a stopped motor. The circuit is designed to maximize motor runtime, and to be applicable to the varying internal resistances and pumping loads of a variety of motors.

### BACKGROUND OF THE INVENTION

1. Field of the Invention

The present invention relates to the field of electronic control circuits, and has an application in the field of solar electricity systems.

2. Discussion of Related Art

Solar powered water heaters are becoming more popular, especially for use in domestic buildings, commercial buildings, and swimming pools. While most heating systems use 110/220 Volt AC power, advanced systems use photovoltaic cell arrays (PV modules) to produce DC electrical power. These advanced systems consist of PV modules, a DC motor, a pump, and an array of solar collector panels. The PV module provides the power to drive the motor, which in turn drives the pump, which in turn pumps a liquid, such as water or an antifreeze solution, through the solar collector panels where it is heated by incident solar energy (see FIG. 3A).

While there is obvious appeal to the use of solar energy to generate hot water, solar heating systems are imperfect due to a variety of issues. One issue is the transformation of the voltage and current levels provided by the PV module. Because the PV module produces energy at different voltage and current values than those required by the motor, a means for converting these properties is required. In prior art, this function is usually performed by a Linear Current Booster (LCB) circuit, which typically requires built-in inductance components. Such a requirement is a limitation, as the particular inductance value of a selected component restricts the circuit to a particular motor size. The extra component also creates additional cost.

The other critical issue in the design of solar heating systems surrounds power availability. A DC motor requires more current to start turning than is required to continue turning, due to startup electrical and physical resistance. In a fluid pump system powered by a PV source, the PV module may be producing enough current to continue turning the motor but not enough current to start turning the motor. The current produced by the PV module is dependent at any given moment on the strength of the available sunlight, the amount of cloud cover, and the position of the sun in the sky, i.e. the incident angle of the solar radiation on the PV module. In early morning, late evening, or in periods of cloud cover, the energy produced by the PV module may drop such that the motor stops. Some time later, the amount of sunlight may increase such that there is enough “continue-turning” energy but not enough “start-turning” energy. In particular, this situation may delay startup in the morning by up to one hour, may reduce daily system runtime during marginal or cloud-cover situations, and may cause the system to stop running prematurely in the evening.

Prior art technology addresses this issue by attempting to determine the “turn status”, (stopped or running) of the motor. In the stopped case, the available energy is stored in a storage device. The stored energy is then applied as a jolt to the motor in an attempt to start it turning. If the motor starts, the available energy from the PV module may now be sufficient to keep the motor running. The limitation of the prior art is the use of fixed voltage setpoints to determine of the “turn status” of the motor. The prior art makes no direct determination of the motor's turning state, but rather uses its measurement of the amount of available energy from the PV module itself to infer the “turn status” of the motor. This limitation means a given DC driver circuit will only work with a particular motor driving a particular pump in a particular hydraulic loop. Thus, the prior art circuits are inflexible as they cannot adjust automatically to a given motor, nor to the changing mechanical characteristics of the motor, pump, and circuit as the system wears and ages.

U.S. Pat. No. 4,483,319, (Dinh), issued Nov. 20, 1984, describes a circuit containing a capacitor which provides a jolt of starting current when first connected to (preferably) a DC motor. The PV module charges the capacitor, which is initially connected to a current draining circuit (rather than the motor). When the charge on the capacitor is sufficient to reach a set voltage, a relay is closed to connect the capacitor and the PV module to the motor. The capacitor provides the startup current in the hope that the PV module will subsequently provide enough current to keep the motor turning. If the PV module does not provide enough current to keep the motor turning (i.e. to keep the relay closed), the relay opens, switching the available PV current from the motor and into the capacitor. The circuit works by closing the relay at a fixed voltage set by a rheostat. The relay dropout point is effectively set via the PV module voltage, since if the voltage drops below a certain level, (due to lack of sunlight), there will be insufficient current to hold the relay in. This method of using fixed voltage setpoints rather than the actual “turn status” of the motor is a limitation, as previously discussed. An additional limitation is that the circuit has no ability to convert the PV module output voltage and current to the necessary motor voltage and current. This absence of a voltage and current conversion mechanism restricts the circuit's use to a particular motor. Furthermore, the maximum charged voltage of the capacitor, and therefore its maximum contribution to starting the motor, is equal to the “running mode” output voltage of the PV cell module, which is typically 15V. The capacitor is not charged to the open circuit voltage of the PV module, so the resulting motor jolt provided by the charged capacitor is quite small. The energy stored in the capacitor is proportional to the maximum charged voltage squared. A still further limitation of this circuit is its use of a failure-prone mechanical relay to accomplish the mode switching.

U.S. Pat. No. 5,621,248, (De Villiers), issued Apr. 15, 1997, has a number of advantageous features over U.S. Pat. No. 4,483,319 (Dinh). It contains a voltage converter circuit which raises the PV module output voltage to provide a greater charge to the capacitor and thus a greater jolt to the motor. It also contains a motor controller circuit whose function is unspecified but is likely to convert the PV module voltage and current to that required by the motor. However, the invention uses a fixed voltage setpoint to determine, via detection by a voltage sensor, when to release the energy from the capacitor to the motor. Presumably, the capacitor discharge voltage will be higher than the “running mode” voltage of the motor. This patent covers a starter rather than a controller, and has no ability to detect or use the actual motor rotation status to either initiate energy storage or to initiate stored energy release. Indeed, it appears that energy storage and triggered release occur frequently, regardless of whether the motor is running or not.

U.S. Pat. No. 4,614,879 (Ault), issued Sep. 30, 1986, describes a circuit which maximizes the available power from the PV module to pump the DC motor with current jolts. These jolts are sufficient to cause the motor to turn and to eventually build up to full rotation speed. The circuit does not use any type of capacitance or other energy storage device for the purpose of maximizing power to the motor. Rather, the circuit attempts, by switching a resistance into and out of circuit with the motor, to operate the PV module at the ‘knee’ of the PV power curve, (the point of maximum power). The circuit uses rapid switching from low voltage-high current mode to high voltage-low current mode to induce jolts of current through the motor to overcome starting resistance. Essentially, this patent discloses a device to operate the PV module at the point of maximum power only. This rapid switching results in a loss of electrical efficiency as the rapid switching of FET (Field Effect Transistor) devices inherently results in heat production. This loss of electrical energy to heat decreases the energy applied to the motor.

### SUMMARY OF THE INVENTION

The present invention describes a DC motor driving circuit that improves upon the known art. In addition to converting the PV module output voltage and current to the voltage and current required by a motor, this DC motor driver circuit also contains a short-term energy storage capability. When the motor is detected to have stopped rotating, the device enters “storage mode” and the available energy is routed to the storage device (typically a capacitor). When the capacitor is fully charged, the stored energy is sent to the motor. This energy should start the motor running, and the ongoing available energy should keep the motor running. If conditions are such that the motor cannot enter and maintain “running mode” through this process, the circuit switches back to “storage mode”, and the ongoing energy is stored until the capacitor is fully charged, and the procedure is used again.

This circuit differs from the prior art in that it uses the apparent resistance of the motor armature itself (rather than fixed voltage setpoints) to determine whether the motor is currently turning, and therefore whether to switch to “storage mode”. This results in a circuit that will automatically adjust to motors of differing electrical characteristics and to the varying resistance or external load of a particular motor over time due to wear, etc. It also provides a direct, and therefore accurate, determination of whether the motor is presently “running” or “stopped”, unlike the prior art circuits, which rely on voltage setpoints for this function.

This circuit maximizes the available stored energy by charging the storage device to the peak open circuit voltage of the input PV module. This increases the jolt of energy subsequently released to the DC motor, thus maximizing the likelihood of the motor restarting in marginal power situations.

This circuit provides a current absorption capability for use in very low power situations (e.g. nighttime). This prevents continuous switching between “storage mode” and “running mode” in cases where the available power is clearly insufficient to keep the motor turning at a desirable rate.

All relevant prior art rely on an inductor to provide the DC-to-DC current boost capability to the motor. The present invention uses the inherent inductance of the motor in conjunction with a bypass diode to provide the linear current boost. This results in a component saving, and therefore a cost savings.

This invention overcomes many of the limitations and restrictions of prior art devices. It maximizes the runtime of the motor, provides the flexibility to be used with a variety of motor sizes, can adapt to changing motor characteristics and hydraulic circuit load due to wear and increased friction, and provides electrical component savings over prior art devices.

In accordance with one aspect of the present invention there is provided a control apparatus for use in controlling a DC electric motor, power to the electric motor being supplied by a low power electrical energy source, the apparatus comprising: an energy storage means; detecting means for detecting a storage energy level of said energy storage means; a rotation sensing means; and a first switching means; wherein said first switching means is controlled by said detecting means for connecting the low power electrical energy source and the energy storage means to the DC electric motor depending on the level of energy stored in said energy storage means, said first switching means also being controlled by said rotation sensing means for connecting the output of said low power electrical energy source to the energy storage means depending on the speed of rotation of said motor.

### BRIEF DESCRIPTION OF THE DRAWINGS

The present invention will be described in detail hereinbelow with the aid of the accompanying drawings, in which:

FIG. 1 is a block diagram of the major components of a device incorporating the present invention.

FIG. 2 is a detailed circuit diagram of a particular embodiment of a device incorporating the present invention.

FIG. 3A describes a typical solar powered water heating system. This drawing illustrates the location of the device described by the present invention with respect to the other components of such a system.

FIG. 3B describes a solar powered irrigation system and illustrates the location of the device described by the present invention with respect to the other components of such a system.

### DETAILED DESCRIPTION OF THE INVENTION WITH REFERENCE TO DRAWINGS

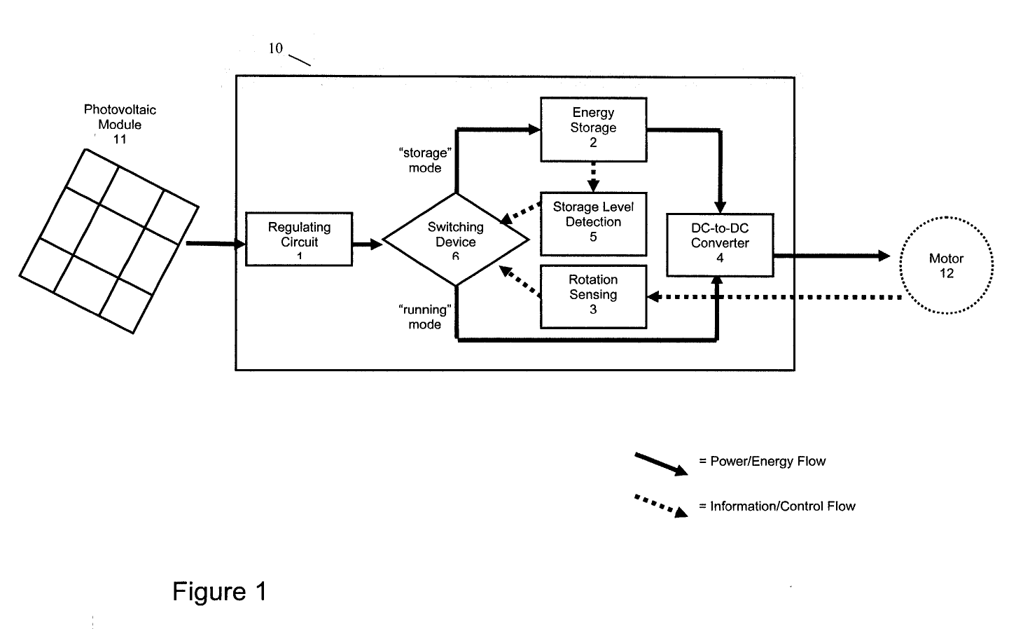

FIG. 1 illustrates the six main components of the DC motor driver circuit 10: a regulating circuit 1, an energy storage device 2, a rotation sensing device 3, a DC-to-DC converter 4, a storage level detection device 5, and a switching device 6.

The power output from the photovoltaic (PV) module 11 is input into the regulating circuit 1. Circuit 1 ensures that the output voltage of the PV module stays at or above the optimum voltage for maximum power output (typically 15V or more). The power from circuit 1 flows through the switching device 6 where, when the motor is in “running mode”, it will be routed to the DC-to-DC converter 4. The function of this converter is to transform the incoming voltage and current levels, typically high voltage, low current, to those required by the motor, typically lower voltage, higher current.

The rotational status of the motor 12 is detected by the rotation sensing means 3 which, should the motor be detected to be stopped or stalling, inputs a signal to the switching device 6. In response to this signal, switching device 6 will switch from “running mode” to “storage mode”. This will cause the power from the regulating circuit 1 to be switched from the motor to the energy storage component 2. When storage level component 5 detects that energy storage component 2 is fully charged, it causes the switching device 6 to switch from “storage mode” to “running mode”. In turn, both the energy from regulating circuit 1 and the energy stored in energy storage component 2 are then released through the DC-to-DC converter 4 to the motor 12. The resulting jolt of power will start the motor 12 turning, and hopefully the motor 12 will continue turning via the available energy from regulating circuit 1.

Energy storage component 2 contains a small power absorbing subcomponent such that when the PV module is producing less power than required to run the DC motor 10 at an optimal level, the device remains in “storage mode”, rather than continually switching between the two modes. This is an important aspect of the invention, without which the motor would continuously try to start but would not run. It should be noted that the proper operation of this circuit does not restrict the location of this subcomponent to energy storage component 2.

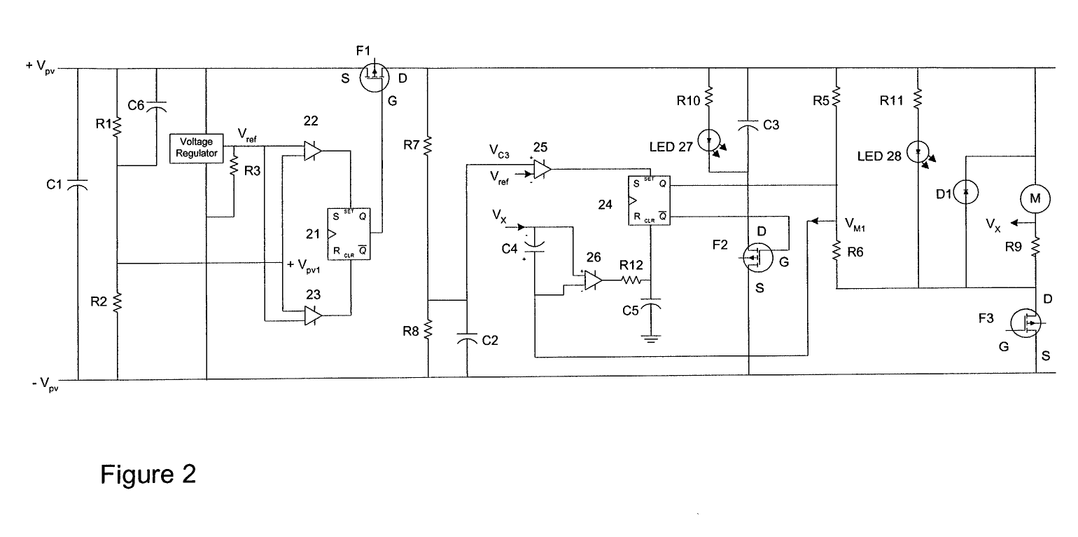

FIG. 2 represents a particular embodiment of a circuit implementing the device of this invention. A detailed description of the operation of this circuit is as follows:

A fixed reference voltage, Vref, is set equal to the desired PV module voltage level, and is provided by a standard voltage regulator integrated circuit in conjunction with resistor R3. The value of Vref is typically set at about 15V for a 12V nominal PV module, such that the available PV power is maximized. Resistors R1 and R2 act as a voltage divider and provide the voltage of the PV module, Vpv1, for comparison with Vref. When Vpv1 falls below Vref, transistor F1 is switched off by flip flop 21, which interrupts the current from the PV module and allows the PV output voltage to rise toward open circuit voltage. When Vpv1 exceeds Vref, transistor F1 is switched on by flip flop 21, which allows current to flow to the motor M or storage capacitor C3. Flip flop 21 is controlled by operational amplifiers 22 and 23, which have as their inputs Vpv1 and Vref. By alternately switching transistor F1 on and off, and charging/discharging capacitor C1, the output voltage from the PV module is averaged (regulated) at the optimum voltage level for maximum PV module output power. Capacitor C1 smoothes the voltage from the PV module, thus reducing the switching frequency of transistor F1. Capacitor C6 eliminates high frequency audible humming from the motor.

It should be noted that Vref can vary considerably from one system to another depending upon the characteristics of the particular PV module and the geographic location of the system. Although the majority of commercially available PV modules claim to be 12V modules, Vref should be set at approximately 15V for these devices. In geographic locations such as the Arctic, Vref could be set as high as 16V due to the lower operating temperatures of the PV module.

Transistors F2 and F3 control the flow of current from the PV module to either the DC motor M or to the energy storage capacitor C3. Normally, F2 is open, preventing capacitor C3 from absorbing charge, and F3 is closed, allowing the available PV current to flow through the motor, rotating it at a speed commensurate with the size of the current. Conversely, if F2 is closed, allowing current to flow to C3, then F3 is open, and no current flows to the motor. This switching of F2 and F3 is controlled by flip flop 24.

Assuming F2 is closed, then F3 is open, and the PV module current flows into C3. As C3 charges, the current output from the PV module decreases, and the PV output voltage rises towards the PV module open circuit voltage.

Resistors R7 and R8 act as a voltage divider across C3 to provide voltage V_{C3}, proportional to the charged voltage of C3. V_{C3} is compared with Vref. When V_{C3} exceeds Vref, C3 is effectively fully charged. The transistors F2 and F3 are then switched by flip flop 24 and operational amplifier 25: F3 is closed and F2 is opened. A delay in the rise of V_{C3} is provided by capacitor C2 to allow storage device C3 to be charged to the maximum possible voltage provided by the PV module. This is an important feature of the circuit, as the energy stored by C3 is proportional to the square of the final voltage across C3. Normally, Vpv is held at 15 volts when using a standard PV module. However, the open circuit voltage of such a PV module is approximately 20V. When C3 is charged to 20V, it stores 78% more energy than if it was charged to only 15V.

When energy storage capacitor C3 is charged to the open circuit voltage of the PV module as described above, transistor F3 is closed and F2 is opened. This results in current flowing from the energy storage capacitor C3 into the motor, providing a jolt to start the motor running. The PV module current now flows to the motor, hopefully providing enough power to keep the motor turning after being started by the current jolt. If the motor continues to rotate, F2 stays open and F3 stays closed. The circuit now monitors the “turn status” of the motor.

The “turn status” of the motor is determined by measuring the apparent armature resistance of the motor, R_{M}. When the motor is running the apparent resistance is high. As the motor approaches stall, the resistance drops to approach the stationary resistance of the armature, Ra. R_{M} is measured indirectly. The motor current I_{M}, is sensed by measuring voltage V_{X} across R9, a current sensing resistor. The motor voltage, V_{M}, is sensed by voltage divider R5 and R6.

So we have

$${I}_{M} = \frac{{V}_{X}}{R9} \qquad and \qquad {R}_{M} = \frac{{V}_{M}}{{I}_{M}}$$

Eliminating I_{M}, we have

$${R}_{M} = \frac{{V}_{M} \cdot R9}{{V}_{X}}$$

For the non-stalled condition we have R_{M}>Ra, or

$$\frac{{V}_{M} \cdot R9}{{V}_{X}} > Ra$$

Rearranging this equation, we have

$${V}_{M} \cdot \frac{R9}{Ra} > {V}_{X}$$

The values of resistors R5 and R6 are selected such that they represent

$$\frac{R9}{Ra}$$

giving us:

$${V}_{M} ( \frac{R6}{R5 + R6} ) > {V}_{X}$$

or as taken from FIG. 2, V_{M1}>V_{X}

V_{M1} and V_{X} are compared by operational amplifier 26. When V_{M1} exceeds V_{X}, the motor resistance is greater than the stationary armature resistance, and the motor is running. Note that motor resistance for a DC motor increases sharply with the slightest rotation of the motor. In this situation, F2 is kept open and F3 is closed, thus feeding PV current directly to the motor. C3 is effectively not in circuit.

When V_{M1} is equal to or less than V_{X}, motor stall is indicated. In this case, operational amplifier 26 resets flip flop 24 which closes F2 and opens F3, and “storage mode” as described above, is in effect. Thus, if there is insufficient PV current to maintain the rotation of the motor, the circuit enters “storage mode” and another jolting cycle begins.

In this way, the circuit uses the decrease in motor resistance to switch into “storage mode”, and uses the “full” state of the energy storage component to switch into “running mode”. If the motor fails to continue rotating, the circuit will again detect the decrease in motor resistance and switch back to “storage mode”.

It should be noted that either or both of R6 and R5 can be adjustable or selectable resistors. This allows the same circuit to be used for a wide variety of DC motors having varying armature resistances Ra.

LED 27 is used to indicate that the capacitor C3 is charging. LED 27 and resistance RIO consume sufficient power to prevent C3 from fully charging and therefore preventing switching between F2 and F3 at very low PV current. This prevents the circuit from repeated attempts to start the motor when the PV current is clearly below the level necessary to maintain rotation. LED 28 is used to indicate the motor is running.

The armature of a DC motor has an inherent inductance L. The energy stored by this inductance is

$$\frac{L \cdot {I}_{M}^{2}}{2}$$

When F3 is closed and the current to the motor is interrupted by the opening of F1, the energy stored in the motor inductance can be recaptured using diode D1. When F1 is opened, current continues to flow through the motor via R9 and D1 due to the discharging energy stored in the internal inductance of the motor armature. In this manner, via the repeated switching of F1 and the action of D1 and R9, the circuit acts as a current booster, or DC-to-DC transformer, converting relatively high Vpv and relatively low Ipv to low V_{M} and high I_{M}. When V_{M} reaches Vpv, the switching of transistor F1 stops and Vpv and V_{M} rise and fall in unison, while V_{M} remains above the predetermined minimum Vpv as set by Vref.

It should be emphasized that FIG. 2 is a particular instance of the device covered by this patent. The particular values and components shown in the circuit of FIG. 2 are for a particular range of PV module and DC motor. It is the particular functions and purposes of the device, as embodied in the circuit of FIG. 2, that are covered by this patent.

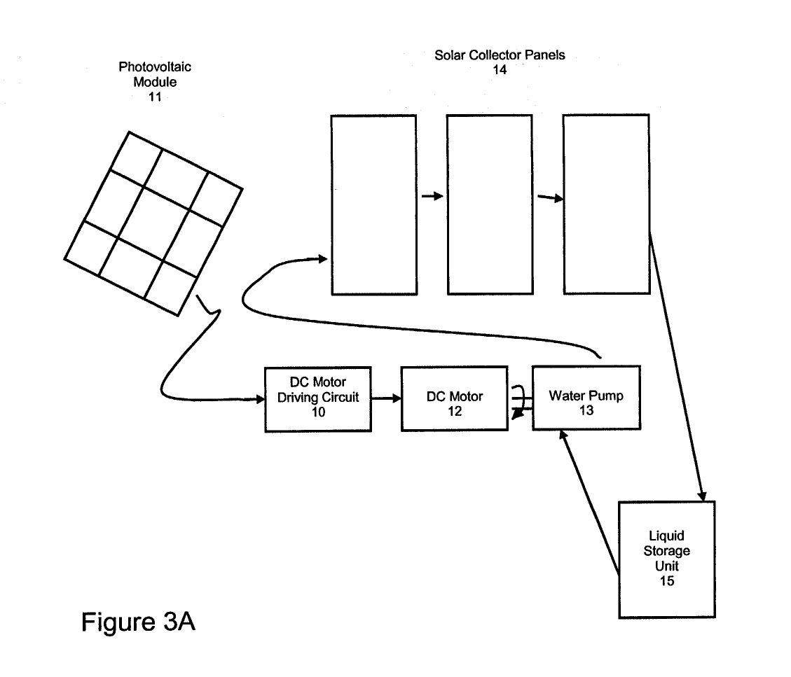

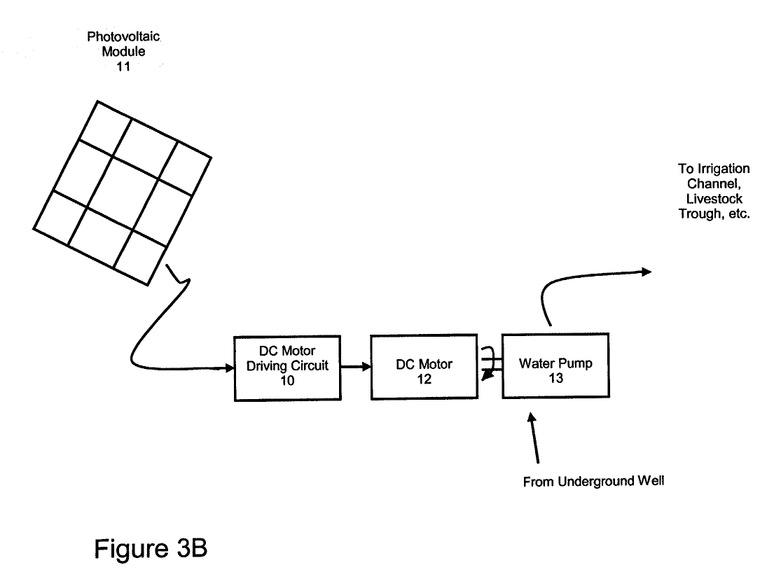

FIG. 3A

This drawing illustrates the use of the device in a solar powered water heating system. The energy from the Photovoltaic Module 11, is directed through the DC Motor Driving Circuit 10, to the DC Motor 12. This motor drives the Water Pump 13, which pumps water from the Liquid Storage Unit 15, through the Solar Collector Panels 14, where it is heated by the sun before being returned to the Liquid Storage Unit 15. Examples of a liquid storage unit include a swimming pool, and a hot water storage tank.

FIG. 3B

This drawing illustrates the use of the device in an irrigation or livestock watering system. The energy from the Photovoltaic Module 11, is directed through the DC Motor Driving Circuit 10, to the DC Motor 12. This motor drives the Water Pump 13, which pumps water from an underground well to an irrigation channel or livestock trough.

Although this document has used a photovoltaic module throughout as the low power electrical energy source, it should be understood that this invention is applicable to driving a DC motor from any variable-level energy source where the available energy can drop below that needed to restart the motor. Other such low power energy sources include wind turbines or water turbines driving electrical energy generators, or conventional commercial grid-based power where available power can be low due to energy transmission losses or unreliable operation.

1. A control apparatus for use in controlling a DC electric motor, power to the electric motor being supplied from a low power electrical energy source, the apparatus comprising:
an energy storage means;
detecting means for detecting a storage energy level of said energy storage means;
a rotation sensing means; and
a first switching means;
wherein said first switching means is controlled by said detecting means for connecting the low power electrical energy source and the energy storage means to the DC electric motor depending on the level of energy stored in said energy storage means, said first switching means also being controlled by said rotation sensing means for connecting the output of said low power electrical energy source to the energy storage means depending on the speed of rotation of said motor.

2. The control apparatus of claim 1, further comprising a regulating circuit means, connecting said low power electrical energy source to said first switching means, for regulating output voltage of said low power electrical energy source at or above an optimum voltage.

3. The control apparatus of claim 2, wherein said regulating circuit means has an input impedance and includes a second switching means, wherein the input impedance oscillates between a normal load and an open circuit when the output voltage of said low power electrical energy source is less than the optimum voltage.

4. The control apparatus of claim 3, further comprising a DC-to-DC converter connected to the DC electric motor for converting the high voltage low current output of said low power electrical energy source to a lower voltage higher current requirement of said DC electric motor.

5. The control apparatus of claim 4, wherein said energy storage means is selected from the group of energy storage means consisting of a capacitor, an inductor and a battery.

6. The control apparatus of claim 5, further comprising absorbing means which consumes sufficient power to prevent said energy storage means from storing sufficient energy in a low power condition to trigger the storage level detection means.

7. The control apparatus of claim 6, wherein said absorbing means is an energy leakage device connected in parallel with said energy storage means.

8. The control apparatus of claim 7, wherein said energy leakage device is a resistor.

9. The control apparatus of claim 4 wherein said DC-to-DC converter is comprised of a diode connected in parallel with a series connection of a resistor and said DC electric motor, operating in conjunction with the operation of the regulating circuit means.

10. The control apparatus of claim 4 wherein said storage means is charged to the open circuit voltage of said low power electrical energy source.

11. The control apparatus of claim 4 wherein said rotation sensing means includes a comparator which produces an output signal to said first switching means to connect said low power electrical energy source to said energy storage means when an apparent armature resistance of said DC electric motor approaches the stationary armature resistance of said DC electric motor.

12. The control apparatus of claim 4 wherein said low power electrical energy source is an array of photovoltaic cells.

13. A control apparatus for use in controlling a DC electric motor, power to the electric motor being supplied from a low power electrical energy source, the apparatus comprising:
an energy storage means;
detecting means for detecting a storage energy level of said energy storage means;
a rotation sensing means; and
a first switching means;
wherein said first switching means is controlled by said detecting means for connecting the low power electrical energy source and the energy storage means to the DC electric motor depending on the level of energy stored in said energy storage means, said first switching means also being controlled by said rotation sensing means for connecting the output of said low power electrical energy source to the energy storage means depending on the speed of rotation of said motor;
regulating circuit means, connecting said low power electrical energy source to said first switching means, for regulating output voltage of said low power electrical energy source at or above an optimum voltage;
a DC-to-DC converter connected to the DC electric motor for converting the high voltage low current output of said low power electrical energy source to a lower voltage higher current requirement of said DC electric motor.
